(19) United States
(12) Patent Application Publication
(10) Pub. No.: US 2006/0028505 A1
(43) Pub. Date: Feb. 9, 2006

(54) Liquid jet head

(75) Inventor: Tetsuo Ikegame, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 11/196,149

(22) Filed: Aug. 3, 2005

(30) Foreign Application Priority Data
Aug. 9, 2004 (JP) 2004-232450

(51) Int. Cl. B41J 2/145; B41J 2/15

(52) U.S. Cl. 347/40

(57) ABSTRACT

End portions on one side of respective heads in a head unit are inserted and arranged in respective spaces between end portions on the other side of respective heads in an adjoining head unit.

### CROSS-REFERENCE TO RELATED APPLICATIONS

This application is based upon and claims the benefit of priority from prior Japanese Patent Application No. 2004-232450, filed Aug. 9, 2004, the entire contents of which are incorporated herein by reference.

### BACKGROUND OF THE INVENTION

1. Field of the Invention

The present invention relates to a printer such as an inkjet printer, a copying machine or a facsimile which ejects liquid droplets of ink or the like with respect to, e.g., a recording medium to perform printing, a micro-eject apparatus for an adhesive, a manufacturing apparatus of a color filter in a liquid crystal display, or the like, and more particularly, it relates to a liquid jet head which is used for ejecting a small amount of liquid droplets of, e.g., ink.

2. Description of the Related Art

For example, an inkjet printer uses a liquid jet head to eject ink from nozzles of a head. This liquid jet head utilizes many heads for high-speed printing onto a recording medium, realization of multicolor printing and other effects. Each of these heads has a nozzle array in which a plurality of nozzles are arranged. As a result, many nozzle arrays are arranged.

For example, Jpn. Pat. Appln. KOKAI Publication No. 2003-320652 relates to a building plate printer, and discloses that this printer comprises a plurality of print heads 1-1 to 1-n and 2-1 to 2-n-1 as shown in FIG. 16. In each of the print heads 1-1 to 1-n and 2-1 to 2-n-1, there are integrally disposed a nozzle array K which ejects black ink, a nozzle array C which ejects cyan ink, a nozzle array M which ejects magenta ink and a nozzle array Y which ejects yellow ink. As a result, each of the print heads 1-1 to 1-n and 2-1 to 2-n-1 has a four-string nozzle array KCMY. Each nozzle array K, C, M or Y has a nozzle array length a. In each of the nozzle arrays K, C, M and Y, a plurality of inkjet nozzles are arranged in a string in a main scanning direction (a Y direction) at a predetermined pitch and in a sub-scanning direction (an X direction) at predetermined intervals b.

The respective print heads 1-1 to 1-n and the respective print heads 2-1 to 2-n-1 are alternately arranged in a zigzag pattern with respect to the main scanning direction (the Y direction) orthogonal to a building plate carrying direction (the X direction). As a result, the respective print heads 1-1 to 1-n and the respective print heads 2-1 to 2-n-1 are arranged in two parallel strings along the building plate carrying direction (the X direction). Therefore, the length of the entire print head with respect to the sub-scanning direction (the X direction) requires a value corresponding to two print heads, e.g., lengths of the print head 1-1 and the print head 2-1.

Jpn. Pat. Appln. KOKAI Publication No. 2003-1855 discloses such an inkjet printer incorporating a recovery device as shown in FIG. 17. This inkjet printer mainly comprises a paper carriage device (not shown) and a head device 4. The head device 4 has 24 liquid jet heads 3A1 to 3D6 each having a nozzle array which ejects ink. The head device 4 comprises four-color head blocks, i.e., a B (black) head block 3A, a C (cyan) head block 3B, an M (magenta) head block 3C and a Y (yellow) head block 3D. For example, the B head block 3A is detachably attached to attachment opening portions 5Al, 5A4 and the like of a head substrate 5A, and comprises six liquid jet heads 3A₁ to 3A₆ which downwardly eject ink. The respective liquid jet heads 3A₁ to 3A₃ and the respective liquid jet heads 3A₄ to 3A₆ are arranged in multiple strings along an inclined line La which is inclined with respect to the X direction or a line parallel to this inclined line La in a full-width region of a recording medium. The C head block 3B, the M head block 3C and the Y head block 3D also have the same configuration.

### BRIEF SUMMARY OF THE INVENTION

There is provided a liquid jet head according to a main aspect of the present invention comprising a plurality of heads each having a nozzle array in which a plurality of nozzles to eject at least liquid droplets are arranged in a line state, wherein the respective heads form at least two head arrays in parallel at predetermined intervals in a second direction substantially orthogonal to a first direction is an arrangement direction of the nozzle array, and end portions on one side of the respective heads in one of the adjoining head arrays are inserted and arranged in respective spaces between end portions on the other side of the respective heads in the other head array.

### BRIEF DESCRIPTION OF THE SEVERAL VIEWS OF THE DRAWING

FIG. 1 is a block diagram showing a first embodiment of an image forming apparatus to which a liquid jet head according to the present invention is applied;

FIG. 2 is a view showing the arrangement of each head in each head unit in the liquid jet head;

FIG. 3 is a block diagram showing the head in the same head unit;

FIG. 4 is a block diagram showing the head in the same head unit;

FIG. 5 is a block diagram showing the head in the same head unit;

FIG. 6 is a block diagram showing the head in the same head unit;

FIG. 7 is a block diagram showing the head in the same head unit;

FIG. 8 is a block diagram of the same head unit;

FIG. 9 is a view showing an arrangement interval of the respective heads in the same head unit;

FIG. 10 is a view showing a state in which the head unit is attached to a carriage in the same liquid jet head;

FIG. 11 is a block diagram showing a head unit which is a second embodiment using the liquid jet unit according to the present invention;

FIG. 12 is a view showing the arrangement when the same head unit is attached to an image forming apparatus;

FIG. 13 is a block diagram showing a head unit which is a third embodiment using the liquid jet head according to the present invention;

FIG. 14 is a view showing the arrangement of heads in the same head unit;

FIG. 15 is a view showing a modification of the same head unit;

FIG. 16 is a block diagram showing a conventional inkjet printer; and

FIG. 17 is a block diagram showing a conventional inkjet printer.

### DETAILED DESCRIPTION OF THE INVENTION

A first embodiment according to the present invention will now be described hereinafter with reference to the accompanying drawings.

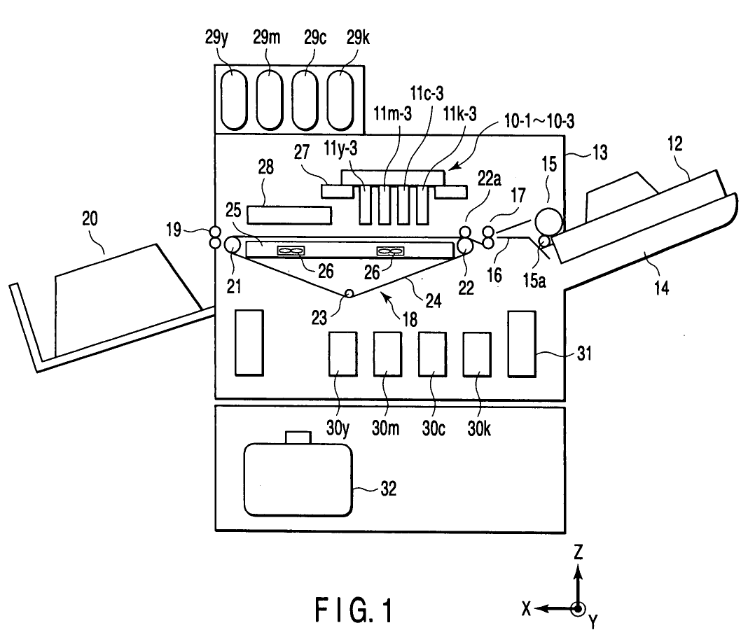

FIG. 1 is a block diagram showing an image forming apparatus to which a liquid jet head is applied. This image forming apparatus adopts an inkjet mode. In this image forming apparatus adopting the inkjet mode, the direction orthogonal to the carriage direction (the X-axis direction) of a recording medium 12 is determined as the Y-axis direction (the main scanning direction) and the carriage direction of the recording medium 12 is determined as the X-axis direction.

The image forming apparatus has respective head units 10-1 to 10-3 holding respective heads 11k-1, 11c-1, . . . , 11y-3. The image forming apparatus ejects respective inks of, e.g., black (which will be referred to as a K color hereinafter), cyan (which will be referred to as a C color hereinafter), magenta (which will be referred to as an M color hereinafter) and yellow (which will be referred to as a Y color hereinafter) from the respective heads 11k-1, 11c-1, . . . , 11y-3 in the respective head units 10-1 to 10-3. Further, the image forming apparatus carries the recording medium 12 such as a paper sheet below the respective heads 11k-1, 11c-1, . . . , 11y-3. As a result, the respective inks having the K color, the C color, the M color and the Y color are spotted onto the recording medium 12. Consequently, a color image is formed on the recording medium 12.

The image forming apparatus roughly has a medium supply/ejection mechanism, a carriage mechanism, an image formation mechanism, an ink supply/accommodation mechanism, and a maintenance mechanism. The medium supply/ejection mechanism performs supply and ejection of the recording medium 12. The carriage mechanism carries the recording medium 12. The image formation mechanism ejects the respective inks of the K color, the C color, the M color and the Y color onto the recording medium 12 carried by the carriage mechanism, thereby forming an image. The ink supply/accommodation mechanism performs supply and accommodation of the respective inks of the K color, the C color, the M color and the Y color. The maintenance mechanism carries out maintenance of the respective heads 11k-1, 11c-1, . . . , 11y-3.

The medium supply/ejection mechanism will now be described. A recording medium supply base 14 is attached to a supply side of an apparatus main body frame 13. The plurality of recording mediums 12 are loaded in the recording medium supply base 14.

A paper feed roller 15 is provided in the apparatus main body frame 13. The paper feed roller 15 comes into contact with one recording medium 12 loaded at an uppermost position of the recording mediums 12 loaded in the recording medium supply base 14, and rotates to feed the recording medium 12 into the apparatus main body frame 13.

A separation roller 15a comes into surface-contact with the paper feed roller 15 and is provided parallel to the paper feed roller 15. The paper feed roller 15 is in surface-contact with a rear side of the surface of the recording medium 12 which is in contact with the separation roller 15a. The paper feed roller 15 rotates in a direction of returning the recording medium 12 toward the recording medium supply base 14 side through, e.g., a torque limiter. As a result, the separation roller 15a does not take out, e.g., the two or more recording mediums 12 in a superposed state from the recording medium supply base 14.

A paper feed guide 16 and a resist roller pair 17 are provided in a paper feed direction of the recording medium 12 taken out by the separation roller 15a. The resist roller pair 17 utilizes looseness of the recording medium 12 produced by contact of an end of the recording medium 12 to feed the recording medium 12 toward a belt platen unit 18 which is the carriage mechanism while correcting obliqueness.

A paper ejection roller pair 19 is provided on an ejection side of the apparatus main body frame 13. The paper ejection roller pair 19 ejects the recording medium 12 having an image formed thereon which is carried from the belt platen unit 18 to the outside of the apparatus main body frame 13. A paper ejection tray 20 is externally attached to the apparatus main body frame 13 on the ejection side. The recording medium 12 ejected to the outside of the apparatus main body frame 13 is accommodated in the paper ejection tray 20.

The carriage mechanism mainly has the belt platen unit 18 and a platen elevation mechanism. The belt platen unit 18 has a driving roller 21 provided on the downstream side in the carriage direction (the X-axis direction) of the recording medium 12, a driven roller 22 provided on the upstream side, and a tension roller 23. The tension roller 23 is provided between the driving roller 21 and the driven roller 22 and below the driving roller 21 and the driven roller 22. An endless belt 24 is wound around the driving roller 21, the driven roller 22 and the tension roller 23. Many suction holes are provided to the belt 24. The belt 24 undergoes tension by the tension roller 23. The belt 24 swivels around the driving roller 21, the driven roller 22 and the tension roller 23 by driving of the driving roller 21. An auxiliary roller 22a is in contact with the driven roller 22.

A suction chamber 25 is provided below the belt 24 which moves between the driving roller 21 and the driven roller 22. A plurality of suction fans 26 are attached on a bottom portion in the suction chamber 25. Each suction fan 26 forms a negative pressure in the suction chamber 25. The driving roller 21, the driven roller 22, the tension roller 23 and the suction chamber 25 constituting the belt platen unit 18 are provided in the apparatus main body frame 13.

Therefore, the belt platen unit 18 vacuums up air through each suction hole of the belt 24 by driving of each suction fan 26 in the suction chamber 25 to suck the recording medium 12 on the belt 24, and carries the recording medium 12 in the X-axis direction (the sub-scanning direction) at a predetermined speed by swiveling of the belt 24. The platen elevation mechanism moves up and down the belt platen unit 18 in a Z-axis direction (an up-and-down direction).

The image formation mechanism has, e.g., the three heads 10-1 to 10-3 and a carriage 27. The respective heads 11k-1, 11c-1, . . . , 11y-3 are mounted on the respective head units 10-1 to 10-3. The head units 10-1 to 10-3 are attached to the carriage 27. The respective heads 11k-1, 11c-1, . . . , 11y-3 are arranged to face a carriage surface of the belt 24 of the belt platen unit 18. The respective heads 11k-1, 11c-1, . . . , 11y-3 have the same configuration and have the respective inks of different colors (KCMY) to be ejected.

The maintenance mechanism has a maintenance unit 28 provided on the downstream side in the carriage direction of the recording medium 12. Like the respective heads 11k-1, 11c-1, . . . , 11y-1, the maintenance unit 28 is arranged to face the carriage surface of the belt 24 in the belt platen unit 18. The maintenance unit 28 is provided in the apparatus main body frame 13.

The ink supply/accommodation mechanism mainly has a plurality of bottles 29k, 29c, 29m and 29y, respective sub-tanks 30k, 30c, 30m and 30y, a suction pump 31 and a waste liquid bottle 32. The respective inks of the K color, the C color, the M color and the Y color are filled in the respective bottles 29k, 29c, 29m and 29y. The respective sub-tanks 30, 30c, 30m and 30y supply the respective inks of the K color, the C color, the M color and the Y color from the respective bottles 29k, 29c, 29m and 29y to the respective heads 11k-1, 11c-1, . . . , 11y-3. The suction pump 31 sucks unnecessary inks. The waste liquid bottle 32 collects and accommodates the inks which are no longer necessary.

The respective bottles 29k, 29c, 29m and 29y are provided at uppermost positions in ink flow paths through which the respective inks of the K color, the C color, the M color and the Y color flow above the apparatus main body frame 13. The respective bottles 29k, 29c, 29m and 29y communicate with the respective sub-tanks 30k, 30c, 30m and 30y through supply paths. The respective inks of the K color, the C color, the M color and the Y color which have overflowed from the respective sub-tanks 30k, 30c, 30m and 30y are accommodated in the waste liquid bottle 32 by the suction pump 31.

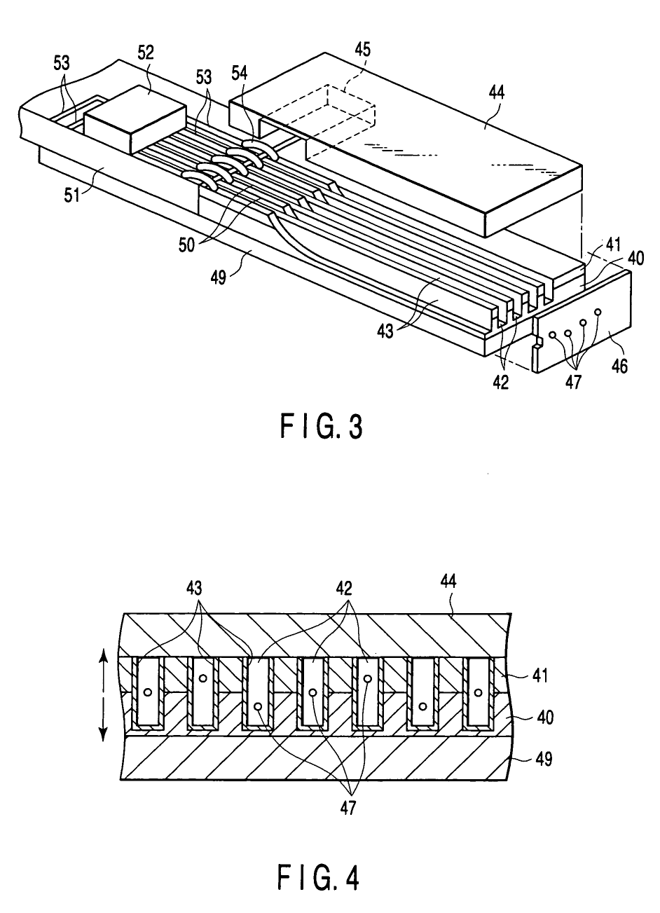

A concrete configuration of the respective heads 11k-1, 11c-1, . . . , 11y-1 will now be described with reference to FIGS. 3 to 7. As the respective heads 11k-1, 11c-1, . . . , 11y-3, an inkjet printer head which is of a share mode type in which an ink chamber is formed by using a piezoelectric member is used. The respective heads 11k-1, 11c-1, . . . , 11y-3 may adopt any other mode such as a bubble jet mode or a configuration using an MEMS.

The respective heads 11k-1, 11c-1, . . . , 11y-3 have the same configuration. Here, a configuration of, e.g., one head 11k-1 will be described, and an explanation of the other heads 11c-1, . . . , 11y-3 will be eliminated.

In the head 11k-1, two piezoelectric members 40 and 41 are attached to each other as shown in FIGS. 3 and 4. The two piezoelectric members 40 and 41 are polarized in directions opposite to their facing directions along a board thickness direction. The respective piezoelectric members 40 and 41 are attached in such a manner that one piezoelectric member 40 is provided on the lower side and the other piezoelectric member 41 is provided on the upper side, for example. A plurality of long grooves 42 are formed on the respective attached piezoelectric members 40 and 41 at fixed intervals in parallel. Each groove 42 is opened on the upper side with respect to the piezoelectric members 40 and 41. Each groove 42 is formed to have a groove bottom which is deep at the front end portion and becomes gradually shallow toward the rear end portion.

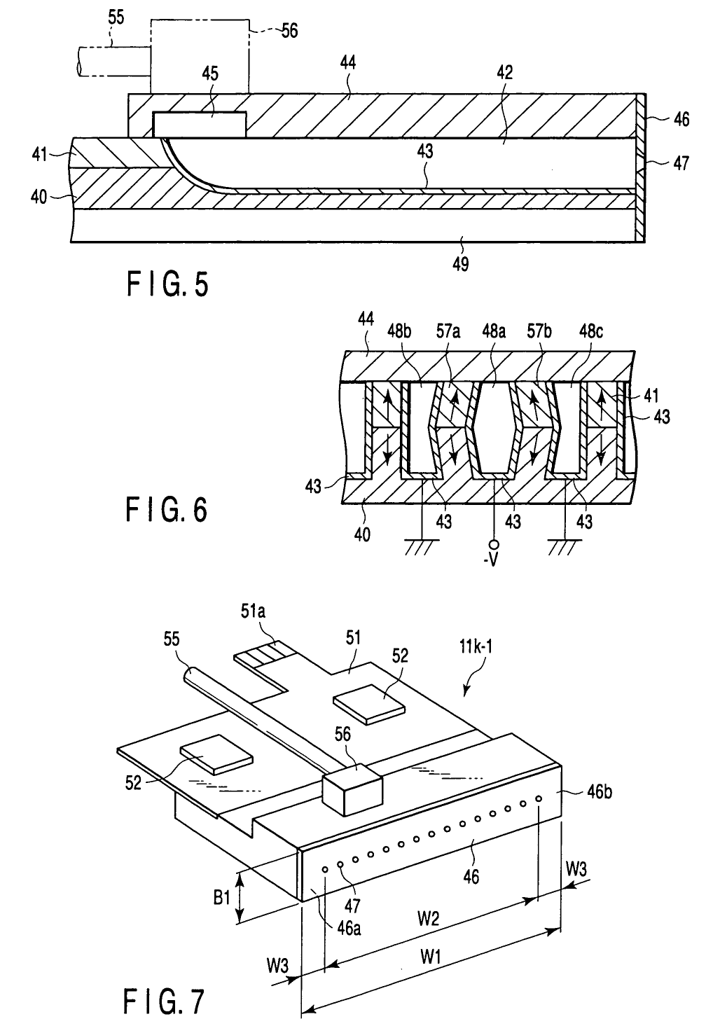

As shown in FIGS. 3 and 5, respective electrodes 43 are formed on side walls and the bottom surface of each groove 42. Each electrode 43 is formed by electroless deposition. The upper portion of each groove 42 is closed by a top panel 44. A common ink chamber 45 is formed on an inner side of the top panel 44. The front end of each groove 42 is closed by a nozzle plate 46. Each nozzle array 47 in which a plurality of nozzles are provided in a line state is formed at each position in the nozzle plate 46 corresponding to each groove 42.

For example, as shown in FIG. 6, respective ink chambers 48a, 48b and 48c are formed of the respective grooves 42 surrounded by the top panel 44 and the nozzle plate 46. The top panel 44, the nozzle plate 46 and the respective ink chambers 48a, 48b and 48c are bonded and fixed to a substrate 49.

As shown in FIG. 3, extraction electrodes 50 are provided. The extraction electrodes 50 are extended from the electrodes 43 to be formed from the rear ends of the respective grooves 42 onto the rear upper surface of the piezoelectric member 41. The extraction electrodes 50 are formed by electroless deposition.

A print circuit board (a PC board) 51 is bonded and fixed on the rear side on the substrate 49. A drive IC 52 having a built-in head driving portion is mounted on the PC board 51. Respective electroconductive patterns 53 are connected with the drive IC 52. A terminal portion 51a is provided to the PC board 51. Each electroconductive pattern and each extraction electrode 50 are coupled with each other through a conductive wire 54 by wire bonding. Each ink of the K color, the C color, the M color or the Y color is supplied into the common ink chamber 45 through a tube fixing member 56 fixed to the top panel 44 from a tube 55.

A driving principle of the head 11k-1 will now be described. As shown in FIG. 6, the respective electrodes 43 of the respective ink chambers 48b and 48c are set to a ground potential. In this state, when a voltage −V is applied to, e.g., the ink chamber 48a for a time T₁, electric fields are generated to respective side walls 57a and 57b of the ink chamber 48a in directions orthogonal to the polarization directions of the respective piezoelectric members 40 and 41. As a result, the respective side walls 57a and 57b are outwardly deformed. The capacity of the ink chamber 48a is increased. A pressure in the ink chamber 48 is reduced, and the ink of the K color, the C color, the M color or the Y color is fetched from the common ink chamber 45.

Next, in a state where the respective electrodes 43 of the respective ink chambers 48b and 48c are set to a ground potential, when a voltage +V is applied to the ink chamber 48a for a time T₂, electric fields are generated to the respective side walls 57a and 57b in directions opposite to the directions orthogonal to the polarization directions of the respective piezoelectric members 40 and 41 and the above-described directions of the electric fields. As a result, the respective side walls 57a and 57b are inwardly deformed. The capacity of the ink chamber 48a is reduced. Consequently, the pressure in the ink chamber 48a is increased, and ink droplets of the K color, the C color, the M color or the Y color are ejected from each nozzle in the nozzle array 47 of the ink chamber 48a.

The nozzle array 47 having the approximately 1240 nozzles is provided on the nozzle plate 46, as shown in FIG. 7. When the respective heads 11k-1, 11c-1, . . . , 1y-3 are attached to the image forming apparatus, the nozzle arrays 47 are arranged in a direction (the Y-axis direction) orthogonal to the carriage direction (the X-axis direction) of the recording medium 12. As to the nozzle array 47, the respective nozzles are provided in one array with a density of, e.g., 300 dpi (an interval of 84.6 μm) in the main scanning direction of the Y-axis direction. A nozzle array length W₂ of the nozzle array 47 in a length W₁ of the nozzle plate 46 in an arrangement direction (the Y-axis direction) of the nozzle array 47 is, e.g., 105 mm.

In order to provide the nozzle array 47 having such a narrow pitch to respective plate end portions on both sides of the nozzle plate 46, rigidity of the walls of the respective piezoelectric members 40 and 41 at both ends must be improved.

Due to such circumstances, respective plate end portions 46a and 46b on which no nozzle array 47 is provided are formed at the both end portions of the nozzle plate 46. The respective plate end portions 46a and 46b have a length W₃. The length W₃ of the respective plate end portions 46a and 46b is, e.g., 5 mm. The length W₁ of the nozzle plate 46 is, e.g., 115 mm.

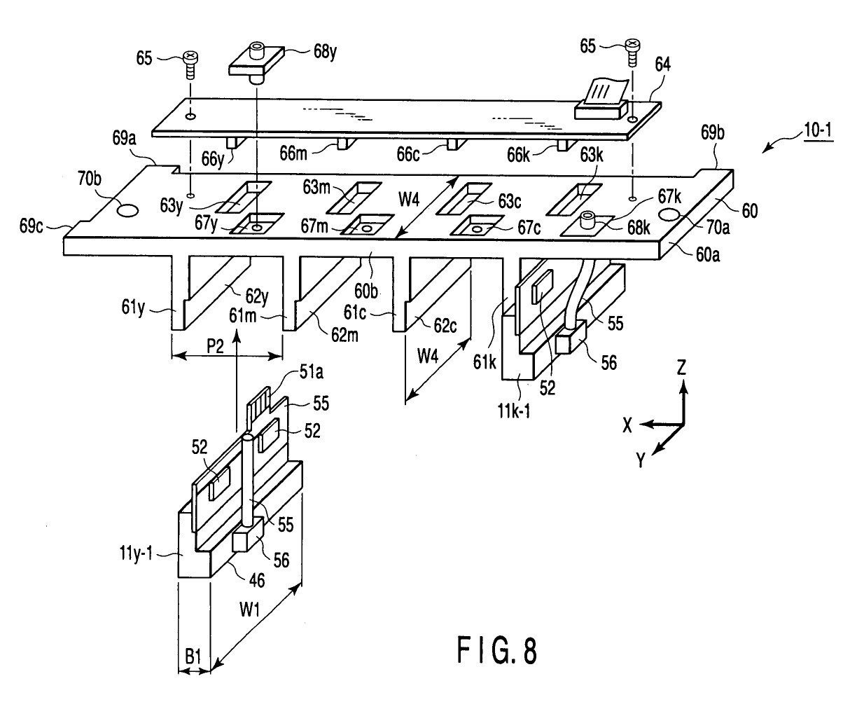

FIG. 8 is a block diagram of the respective head units 10-1 to 10-3. The respective head units 10-1 to 10-3 have the same configuration. Here, for example, one head unit 10-1 will be described, and an explanation of the other head units 10-2 and 10-3 will be eliminated.

The head unit 10-1 has a head plate 60 as a tabular holding member formed into a strip-like shape. The head plate 60 has a short side 60a and a long side 60b. When the head plate 60 is provided in the image forming apparatus, the short side 60a is provided along the Y-axis direction (the main scanning direction) which is the arrangement direction of the nozzle array 47, and the long side 60b is provided along the X-axis direction (the sub-scanning direction) which is vertical to the arrangement direction of the nozzle array 47.

A plurality of head attachment portions 61k, 61c, 61m and 61y are provided on one surface (a lower surface) of the head plate 60. The respective head attachment portions 61k, 61c, 61m and 61y are provided at a predetermined second pitch P₂ in the X-axis direction along the long side 60b. Each of the head attachment portions 61k, 61c, 61m and 61y is formed into a downwardly protruding shape from the lower surface of the head plate 60. Respective attachment step portions 62k, 62c, 62m and 62y are provided on respective protruding lower sides of the head attachment portions 61k, 61c, 61m and 61y. The longitudinal direction of each of the head attachment portions 61k, 61c, 61m and 61y is provided along the Y-axis direction (the main scanning direction). The length of each head attachment portion 61k, 61c, 61m or 61y in the longitudinal direction is set to W₄ which is equal to the width W₄ of the short side 60a of the head plate 60.

The respective heads 11k-1, 11c-1, 11m-1 and 11y-1 are attached to the respective attachment step portions 62k, 62c, 62m and 62y. As a result, a head array consisting of the respective heads 11k-1, 11c-1, 11m-1 and 11y-1 is formed. It is to be noted that FIG. 8 shows a state where the head 11k-1 is attached to the attachment step portion 62k and the head 11y-1 is going to be attached to the attachment step portion 62y.

Respective positioning protrusions 69a, 69b and 69c are provided at respective corner portions of the head plate 60. The respective positioning protrusions 69a and 69b are provided to protrude in the Y-axis direction. The respective positioning protrusions 69a and 69b perform positioning in the Y-axis direction when attaching the head plate to the carriage 27. The positioning protrusion 69c is provided to protrude in the X-axis direction. The positioning protrusion 69c performs positioning in the X-axis direction when attaching the head plate to the carriage 27.

In case of attaching the respective heads 11k-1, 11c-1, 11m-1 and 11y-1 to the respective attachment step portions 62k, 62c, 62m and 62y of the head plate 60, respective positions of both end portions of the respective nozzle arrays 47 of the heads 11k-1, 11c-1, 11m-1 and 11y-1 in the Y-axis direction substantially match each other. In order to match both end portions of the respective nozzle arrays 47, positions of both end portions of the nozzle arrays 47 are detected by, e.g., a microscope, and the respective heads 11k-1, 11c-1, 11m-1 and 11y-1 are subjected to positional adjustment in the Y-axis direction with respect to the head plate 60 based on this detection result. This adjustment is carried out with the respective positioning protrusions 69a, 69b and 69c being determined as references. Consequently, when the respective head plates 60 of the head units 10-1 to 10-3 are attached to the carriage 27, positional adjustment of the respective heads 11k-1, 11c-1, . . . , 11y-3 does not have to be performed.

Rectangular holes 63k, 63c, 63m and 63y are formed in the head plate 60. The respective holes 63k, 63c, 63m and 63y correspond to the respective positions of the heads 11k-1, 11c-1, 11m-1 and 11y-1. A connection substrate 64 is fixed on the upper surface of the head plate 60 by fastening respective screws 65. Respective connectors 66k, 66c, 66m and 66y are provided on the lower surface of the connection substrate 64 in accordance with positions of the respective holes 63k, 63c, 63m and 63y.

Therefore, in a state where the respective connectors 66k, 66c, 66m and 66y are inserted into the respective holes 63k, 63c, 63m and 63y of the head plate 60, the connection substrate 64 is attached to the upper surface of the head plate 60. In this state, the heads 11k-1, 11c-1, 11m-1 and 11y-1 are respectively attached to the attachment step portions 62k, 62c, 62m and 62y. In this case, the respective terminal portions 51a of the heads 11k-1, 11c-1, 11m-1 and 11y-1 are connected with the connectors 66k, 66c, 66m and 66y through the holes 63k, 63c, 63m and 63y.

Respective rectangular filter attachment holes 67k, 67c, 67m and 67y are provided to the head plate 60. The respective filter attachment holes 67k, 67c, 67m and 67y correspond to positions of the respective heads 11k-1, 11c-1, 11m-1 and 11y-1. Filters 68k, 68c, 68m and 68y are respectively fixedly provided in the filter attachment holes 67k, 67c, 67m and 67y. It is to be noted that the drawing shows the respective filters 68k and 68y alone for the convenience of illustration.

One end of each tube 55 extending from each of the heads 11k-1, 11c-1, 11m-1 and 11y-1 is coupled with a lower portion of each of the filters 68k, 68c, 68m and 68y. Each of the filters 68k, 68c, 68m and 68y removes foreign particles in each ink of the K color, the C color, the M color or the Y color flowing in the tube 55 from each of the bottles 29k, 29c, 29m and 29y via each of the sub-tanks 30k, 30c, 30m and 30y.

Respective holes 70a and 70b for attachment are provided at both ends of the head plate 60.

In the head unit 10-1 having the above-described configuration, the width of the short side 60a of the head plate 6, i.e., the length W₄ of each of the head attachment portions 61k, 61c, 61m and 61y is shorter than the length W₁ of the nozzle plate 46 of each of the heads 11k-1, 11c-1, . . . , 11y-3 and the length W₂ of the nozzle array 47, and satisfies the following expression:
W₄≦W₂−2·W₃ (1)

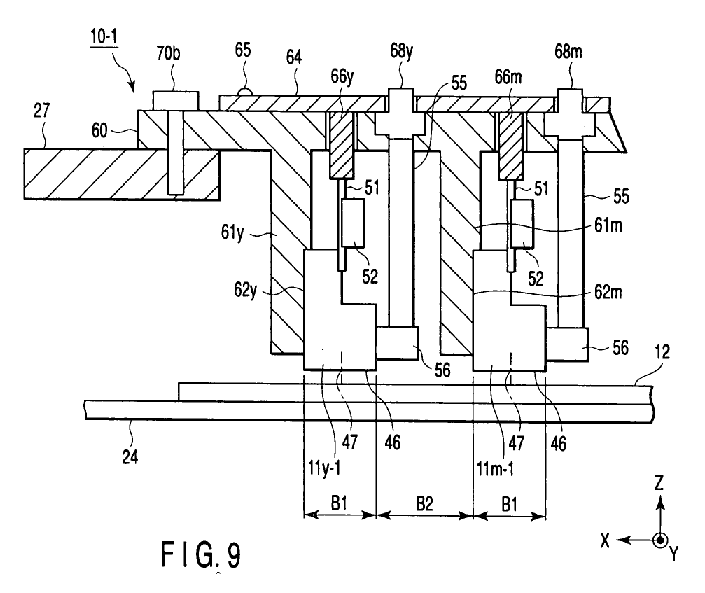

As shown in FIG. 9, each interval B₂ between the respective adjacent heads 11k-1, 11c-1, . . . , 11y-3 is set equal to or longer than a thickness B₁ of each of the heads 11k-1, 11c-1, . . . , 11y-3 at a peripheral portion of the nozzle plate 46 in the X-axis direction. In this embodiment, the thickness B₁ is set to, e.g., 6 mm, and the interval B₂ is set to, e.g., 6.5 mm.

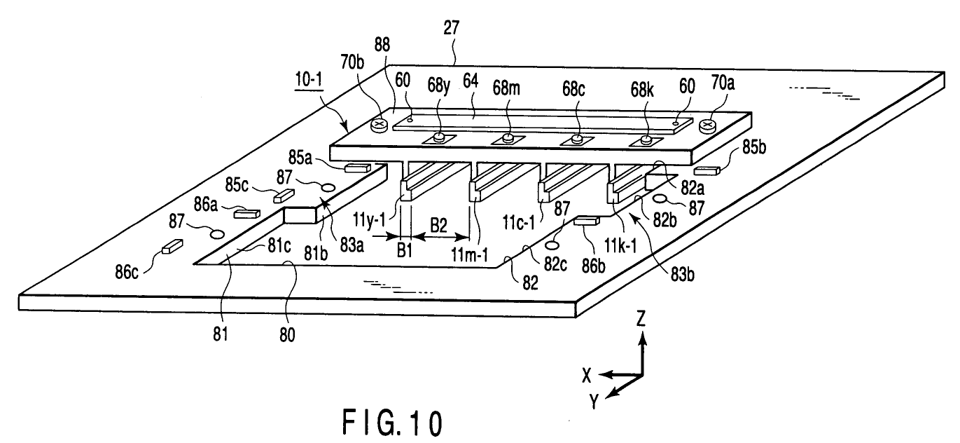

FIG. 10 shows a state where the head unit 10-1 is attached to the carriage 27. The carriage 27 is formed into a rectangular tabular shape. The carriage 27 has an opening portion 80 formed at a central portion. In the opening portion 80, a convex attachment portion 83a and a concave attachment portion 83b are formed at respective sides 81 and 82 facing each other at the central portion in the X-axis direction. The respective attachment portions 83a and 83b are formed in order to attach the three head units 10-1 to 10-3 in such a manner that these units are staggered with a predetermined distance in the X-axis direction.

Therefore, the head unit 10-1 is attached between a first side 81a and the other first side 82a of the respective opposing sides 81 and 82. The head unit 10-2 is attached between a first side 81b and the other first side 82b. The head unit 10-3 is attached between a first side 81c and the other first side 82c.

Respective positioning protrusions 84a, 84b, 84c, 85a, . . . , 86c are provided as respective positioning members on the carriage 27 surface. The respective positioning protrusions 84a, 84b, 84c, 85a, . . . , 86c position the three head units 10-1 to 10-3 in the X-axis direction and the Y-axis direction. For example, the respective positioning protrusions 84a, 84b and 84c position the head unit 10-1 in the X-axis direction and the Y-axis direction. The respective positioning protrusions 84a and 84b come into contact with the respective positioning protrusions 69a and 69b of the head plate 60 to position the head unit 10-1 in the Y-axis direction. The positioning protrusion 84c comes into contact with the positioning protrusion 69c of the head plate 60 to position the head unit 10-1 in the X-axis direction.

The respective positioning protrusions 85a, 85b and 85c likewise position the head unit 10-2 in the X-axis direction and the Y-axis direction. The respective positioning protrusions 85a and 85b come into contact with the respective positioning protrusions 69a and 69b of the head plate 60 of the head unit 10-2 to position the head unit 10-2 in the Y-axis direction. The positioning protrusion 85c comes into contact with the positioning protrusion 69c of the head plate 60 to position the head unit 10-2 in the X-axis direction.

The respective positioning protrusions 86a, 86b and 86c likewise position the head unit 10-3 in the X-axis direction and the Y-axis direction. The respective positioning protrusions 86a and 86b come into contact with the respective positioning protrusions 69a and 69b of the head plate 60 of the head unit 10-3 to position the head unit 10-3 in the Y-axis direction. The positioning protrusion 86c comes into contact with the positioning protrusion 69c of the head plate 60 to position the head unit 10-3 in the X-axis direction.

Each screw hole 87 is provided on the carriage 27 surface. Each screw hole 87 is provided to respectively attach and fix the three head units 10-1 to 10-3.

The carriage 27 and the head plate 60 are formed by the same aluminum die casting and have the same thermal expansion coefficient. As a result, the carriage 27 and the head plate 60 are prevented from being deformed by the same thermal expansion.

The three head units 10-1 to 10-3 are fixed by fitting each screw 88 in each screw hole 87 on the carriage 27 surface. As a result, the respective head units 10-1 to 10-3 are provided with the longitudinal direction thereof being set along the carriage direction (the X-axis direction) of the recording medium 12.

For example, in case of attaching the head unit 10-1 on the carriage 27 surface, the respective positioning protrusions 69a and 69b of the head plate 60 are brought into contact with the respective positioning protrusions 84a and 84b to position the head unit 10-1 in the Y-axis direction, and the positioning protrusion 69c is brought into contact with the positioning protrusion 84c to position the same in the X-axis direction.

Likewise, the respective positioning protrusions 69a and 69b of the head plate 60 are brought into contact with the respective positioning protrusions 85a and 85b to position the head unit 10-2 in the Y-axis direction, and the positioning protrusion 69c is brought into contact with the positioning protrusion 85c to position the same in the X-axis direction.

The respective positioning protrusions 69a and 69b of the head plate 60 are brought into contact with the respective positioning protrusions 86a and 86b to position the head unit 10-3 in the Y-axis direction, the positioning protrusion 69c is brought into contact with the positioning protrusion 86c to position the head unit 10-3 in the X-axis direction.

Incidentally, in case of attaching the three head units 10-1 to 10-3 on the carriage 27 surface, the position and inclination of the head plate 60 are adjusted with respect to the carriage 27 surface as required.

When the three head units 10-1 to 10-3 are attached on the carriage 27 surface in this manner, the head units 10-1 to 10-3 are provided in parallel with each other on the carriage 27 surface. At this time, the respective head units 10-1 to 10-3 are provided at a predetermined first pitch P1 (a P pitch) in the Y-axis direction.

As a result, in the head unit 10-1, the head 11k-1 of the K color, the head 11c-1 of the C color, the head 11m-1 of the M color and the head 11y-1 of the Y color area arranged from the upstream side toward the downstream side in the carriage direction of the recording medium 12. Likewise, in the head unit 10-2, the head 11k-2 of the K color, the head 11c-2 of the C color, the head 11m-2 of the M color, and the head 11y-2 of the Y color are arranged from the upstream side toward the downstream side in the carriage direction of the recording medium 12. In the head unit 10-3, the head 11k-3 of the K color, the head 11c-3 of the C color, the head 11m-3 of the M color and the head 11y-3 of the Y color are arranged.

The respective heads 11k-1, 11c-1, . . . , 11y-3 in the respective head units 10-1 to 10-3 are arranged along the direction (the Y direction) orthogonal to the carriage direction (the X-axis direction) of the recording medium 12.

Therefore, the respective nozzle arrays 47 in the respective heads 11k-1, 11c-1, . . . , 11y-3 are arranged along the main scanning direction which is the direction (the Y direction) orthogonal to the carriage direction (the X-axis direction) of the recording medium 12.

In case of attaching the respective head units 10-1 to 10-3 to the carriage 27, the head unit 10-2 is attached between the convex attachment portion 83a and the concave attachment portion 83b as shown in FIG. 10. Gaps between the head unit 10-2 and the adjoining head units 10-1 and 10-3 on the both sides in the X-axis direction are provided to be shifted at predetermined intervals. That is, for example, a gap between the head 11k-1 and the head 11k-2 is provided to be shifted by a distance corresponding to an interval (B₁+B₂)/2 which is ½ of a predetermined second pitch P₂ (=B₁+B₂).

As a result, end portions on one side of one head array, e.g., the heads 11k-1, 11c-2, 11m-2 and 11y-2 of the head unit 10-2 are inserted and arranged between end portions on the other side of the other head array, e.g., the heads 11k-1, 11c-1, 11m-1 and 11y-1 of the head unit 10-1 and in respective spaces 89a, 89b, 89c and 89d on the sides of these end portions and/or between these end portions. For example, one end portion of the head 11y-2 is adjacent to the other end portion of the head 11y-1, and inserted and arranged in the space 89d between the other end portions of the head 11y-1 and the head 11m-1.

With such an arrangement of the respective heads 11k-1, 11c-1, . . . , 11y-3 in the respective head units 10-1 to 10-3, the first predetermined pitch P1 between the head units 10-1 to 10-3 is set equal to or shorter than the length W₂ of each nozzle array 47 in each of the heads 11k-1, 11c-1, . . . , 11y-1.

As a result, for example, a position of one end portion of each nozzle array 47 in each of the heads 11k-1, 11c-1, 11m-1 and 11y-1 in the head unit 10-1 matches with or overlaps a position of the other end portion of each nozzle array 47 in each of the heads 11k-2, 11c-2, 11m-2 and 11y-2 in the adjoining head unit 10-2 as seen from the X-axis direction.

Likewise, a position of one end portion of each nozzle array 47 of each of the heads 11k-2, 11c-2, 11m-2 and 11y-2 matches with or overlaps a position of the other end portion of each nozzle array 47 of each of the heads 11k-3, 11c-3, 11m-3 and 11y-3 between the adjacent head units 10-2 and 10-3 as seen from the X-axis direction.

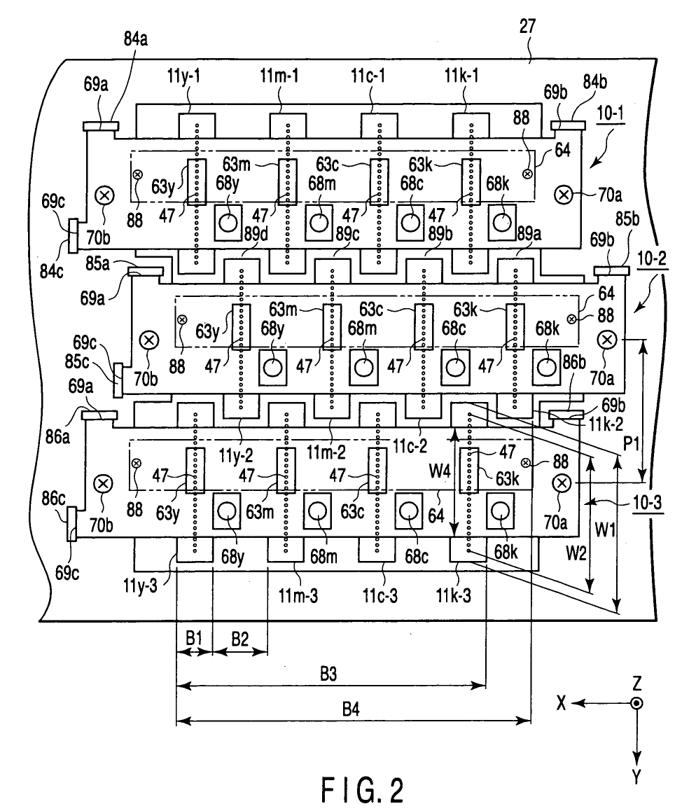

Each tube 55 of each of the heads 11k-1, 11c-1, . . . , 11y-3 and each tube fixing member 56 protruding from each of the heads 11k-1, 11c-1, . . . , 11y-3 in the X-axis direction are arranged in each space of an interval B₂ between the respective heads 11k-1, 11c-1, . . . , 11y-3 adjacent to each other in the X-axis direction as shown in FIG. 2 and FIG. 9.

As described above, the carriage 27 on which the respective head units 10-1 to 10-3 are mounted is fixed to the frame 13 as shown in FIG. 1.

With the arrangement of the respective heads 11k-1, 11c-1, . . . , 11y-3 mentioned above, even if each interval between the respective heads 11k-1, 11c-1, . . . , 11y-3 arranged on the head plate 60 is as wide as B₂, the length B₄ of the respective heads 11k-1, 11c-1, . . . , 11y-3 in the entire image forming apparatus shown in FIG. 2 in the X-axis direction can be set to substantially the length in the X-axis direction of the respective eight heads 11k-1, 11c-1, . . . , 11y-3 in which two sets of the four colors KCMY are provided.

A total of the 12 heads 11k-1, 11c-1, . . . , 11y-3 are arranged in such a manner that the respective heads of the same color, e.g., the respective heads 11k-1, 11k-2 and 11y-3 of the K color are staggered along the Y-axis direction. The respective heads are arranged in such a manner that positions of the both end portions of the respective nozzle arrays 47 match with or overlap each other as seen from the X-axis direction. In the respective heads 11k-1, 11c-1, . . . , 11y-3, eject timings of ejecting the respective inks having the colors KCMY can be adjusted by a control portion or the like in accordance with each of the heads 11k-1, 11c-1, . . . , 11y-3.

For example, it is possible to record with four colors, i.e., the K color, the C color, the M color and the Y color within the length W₂ of the nozzle array 47 formed in the nozzle plate 60 of one head 11k-1 in one head unit 10-1.

As a result of such arrangement of the respective heads 11k-1, 11c-1, . . . , 11y-3, each of the heads 11k-1, 11c-1, . . . , 11y-3 is apparently equal to a head provided with a nozzle array having, e.g., a nozzle pitch of 300 dpi, 3720 nozzles and a string length of 315 mm.

When the eject timings of the respective inks of the K color, the C color, the M color and the Y color from the respective heads 11k-1, 11c-1, . . . , 11y-3 are adjusted, one straight line can be formed on the recording medium 12 in the Y-axis direction which is the main scanning direction.

As shown in FIG. 9, each nozzle plate 46 on which the nozzle array 47 of each of the heads 11k-1, 11c-1, . . . , 11y-3 is formed is arranged to face the belt 24, and also arranged in such a manner that a gap of approximately 1 mm between the nozzle plate 46 and the surface of the belt 24, which is specifically a distance of approximately 1 mm between the nozzle plate 46 and the recording medium 12 sucked and carried by the belt 24 is formed.

An image forming operation by the apparatus having the above-mentioned configuration will now be described.

First, the recording mediums 12 supplied from the recording medium supply base 14 are fed into the apparatus main body frame 13 by the paper feed roller 15. The recording mediums 12 are divided into each piece by the separation roller 15a, and then comes into contact with the resist roller pair 17. The resist roller pair 17 adjusts a timing and resupplies the recording medium 12. An end of the recording medium 12 is nipped between the auxiliary roller 22a and the belt 24, and the recording medium 12 is carried onto the belt 24 of the belt platen unit 18.

The recording medium 12 mounted on the belt 24 is sucked from the end thereof on the belt 24 by a suction force (a negative pressure) generated by driving of each suction fan 26. That is, the belt platen unit 18 performs suction of air through each suction hole of the belt 24 by driving of each suction fan 26 in the suction chamber 25. As a result, the recording medium 12 is sucked on the belt 24. In this state, the recording medium 12 is carried in the X-axis direction (the sub-scanning direction) by movement of the belt 24 at a predetermined speed. Consequently, the recording medium 12 travels below the respective heads 11k-1, 11c-1, . . . , 11y-3.

As this time, for example, a line sensor (CCD) arranged immediately after the auxiliary roller 22a in the carriage direction reads a change in a position of the recording medium 12. The control portion reads a signal from the line sensor, and controls timings of the respective inks having the K color, the C color, the M color and the Y color ejected from each nozzle array 47 of each of the heads 11k-1, 11c-1, . . . , 11y-3. Specifically, the control portion calculates a timing at which the end portion of the recording medium 12 travels below each of the head units 10-1 to 10-3 along the carriage direction, and matches the obtained timing with the eject start timing of each ink having the K color, the C color, the M color or the Y color ejected from each of the heads 11k-1, 11c-1, . . . , 11y-3.

After the recording medium 12 reaches a position below each of the heads 11k-1, 11k-2 and 11k-3 of the K color, the recording medium 12 is then sequentially carried below the respective heads 11c-1, 11c-2 and 11c-3 of the C color, the respective heads 11m-1, 11m-2 and 11m-3 of the M color, and the respective heads 11y-1, 11y-2 and 11y-3 of the Y color.

In the respective heads 11k-1, 11k-2 and 11k-3 of the K color, the respective heads 11c-1, 11c-2 and 11c-3 of the C color, the respective heads 11m-1, 11m-2 and 11m-3 of the M color and the respective heads 11y-1, 11y-2 and 11y-3 of the Y color, the eject start timings of the respective inks having the K color, the C color, the M color and the Y color are achieved. The respective inks of the K color, the C color, the M color and the Y color ejected from the respective heads 11k-1, 11k-2 and 11k-3 of the K color, the respective heads 11c-1, 11c-2 and 11c-3 of the C color, the respective heads 11m-1, 11m-2 and 11m-3 of the M color and the respective heads 11y-1, 11y-2 and 11y-3 of the Y color are spotted onto the surface of the recording medium 12. As a result, an image is formed on the surface of the recording medium 12.

A reference of the ink eject timings is carried out in accordance a pulse signal generated from an encoder provided in the belt platen unit 18. The pulse signal from the encoder is produced in accordance with a movement amount of the belt 24.

On the other hand, the carriage speed of the recording medium 12 is fixed. As a result, color shift of an image formed by the respective colors KCMY can be suppressed to a minimum level. Then, the recording medium 12 having an image formed thereon is ejected by the paper ejection roller pair 19, and accommodated in the paper ejection tray 20.

As described above, according to the first embodiment, between the end portions of the respective heads 11k-1, 11c-1, 11m-1 and 11y-1 of, e.g., the head unit 10-1 on one side and in the respective spaces 89a, 89b, 89c and 89d on the side of these end portions and/or between these end portions, the end portions of the respective heads 11k-2, 11c-2, 11m-2 and 11y-2 of, e.g., the head unit 10-2 on the other side are inserted and arranged. As a result, the entire liquid jet head can be reduced in size. Besides, blurring due to the respective inks of the K color, the C color, the M color and the Y color on the recording medium 12 can be prevented from occurring.

That is, positions of the end portions of the respective nozzle arrays 47 of the heads 11k-1, 11c-1, 11m-1 and 11y-1 in, e.g., the head unit 10-1 on one side can match with or overlap positions of the end portions of the respective nozzle arrays 47 of the heads 11k-2, 11c-2, 11m-2 and 11y-2 in the adjacent head unit 10-2 on the other side as seen from the X-axis direction. Consequently, the first predetermined pitch P1 between the respective head units 10-1 to 10-3 can be set equal to the length W₂ of each nozzle array 47 in the respective heads 11k-1, 11c-1, . . . , 11y-3 or shorter than the length W₂ of the nozzle array. As a result, the dimension of the entire head in the X-axis direction can be reduced.

The respective inkjet heads 11k-1, 11c-1, . . . , 11y-3 of the four colors (KCMY) suitable for full-color printing are provided on the head plate 60 at the second intervals B₂ in the X-axis direction which is the carriage direction of the recording medium 12. Consequently, it is possible to increase each interval between eject times of the respective inks having the K color, the C color, the M color and the Y color ejected from the four heads, e.g., the heads 11k-1, 11c-1, 11m-1 and 11y-1 in the head unit 10-1 onto the same position of the recording medium 12.

As a result, it is possible to increase a time from spotting of the preceding ink onto the recording medium 12 to spotting of the next ink onto the recording medium 12. Consequently, the spotted ink soaks into or becomes dry on the recording medium 12, then the next ink is spotted onto the recording medium 12. Such spotting timings of the inks can avoid blurring of the inks.

The tube 55, the tube fixing member 56 and the respective head attachment portions 61k, 61c, 61m and 61y are arranged in the interval B₂ which include the respective spaces 89a, 89b, 89c and 89d of the respective heads 11k-1, 11c-1, . . . , 11y-2 of the respective head units 10-1 and 10-2, for example. As a result, even if the respective plate ends 46a and 46b at which the nozzle array 47 is not provided are formed at the both end portions of the nozzle plate 46, the respective heads 11k-1, 11c-1, . . . , 11y-3 of the head unit 10-1 do not interfere with the respective heads 11k-1, 11c-1, . . . , 11y-3 of the adjoining head unit 10-2, for example. As a result, a dimension for arranging the respective heads 11k-1, 11c-1, . . . , 11y-3 in the X-axis direction can be reduced.

The respective heads 11k-1, 11c-1, . . . , 11y-3 are fixed at the respective head attachment portions 61k, 61c, 61m and 61y of the head plate 60 formed by head aluminum die casting. As a result, heat generated in the respective heads 11k-1, 11c-1, . . . , 11y-3 can be transmitted to the head plate 60 and the carriage 27 through the respective head attachment portions 61k, 61c, 61m and 61y to be effectively released. The respective head attachment portions 61k, 61c, 61m and 61y can serve as cooling members.

The respective heads 11k-1, 11c-1, . . . , 11y-3 of the K color, the C color, the M color and the Y color are fixed to the head plate 60 to be formed into a unit (the head units 10-1 to 10-3). Consequently, changing the number of the head units 10-1 to 10-3 to be attached can cope with various kinds of recording widths. For example, in this embodiment, the length W₂ of the nozzle array 47 of the one head (e.g., the head 11k-1) is set to, e.g., 105 mm, and the three head units 10-1 to 10-3 are used. As a result, the recording width can be set to 315 mm. Therefore, when, e.g., a cut sheet is used as the recording medium 12, recording can be effected on the recording medium 12 without moving the respective heads 11k-1, 11c-1, . . . , 11y-3 in the main scanning directions (the Y-axis direction).

When two head units are used, the recording width becomes 210 mm. As a result, recording can be performed on the recording medium 12 of up to an A4 size. When one head unit is used, a printing width becomes 105 mm. Therefore, recording can be carried out on the recording medium 12 of, e.g., an A6 size such as a postcard. When four or more head units are used, a wider recording range can be realized.

In this manner, when the respective head units 10-1 to 10-3 or the like having the same configuration are used, just changing the number of these units to be arranged in the widthwise direction of the recording medium 12 can cope with various kinds of recording widths. As a result, it is possible to inexpensively facilitate production of the image forming apparatus such as a printer using various kinds of liquid jet units.

A second embodiment according to the present invention will now be described with reference to the accompanying drawings. It is to be noted that the same reference numeral denote parts equal to those in FIG. 7, thereby eliminating their detailed explanation.

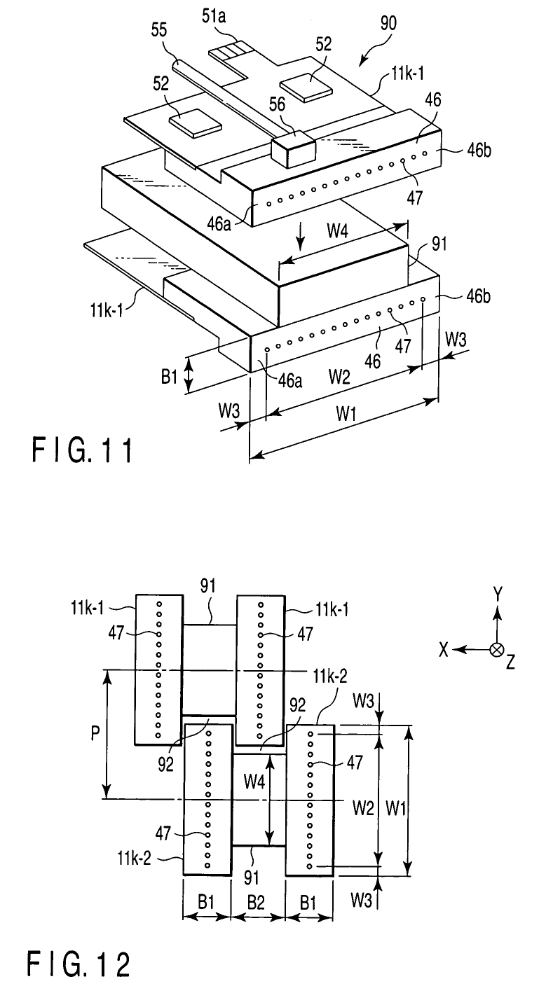

FIG. 11 is a block diagram showing a head unit used in an image forming apparatus. In a head unit 90, for example, the two heads 11k-1 of the respective heads 11k-1, 11c-1, . . . , 11y-3 in the first embodiment face each other through a plate 91.

For example, a nozzle array 47 in the head 11k-1 has, e.g., 300 dpi. In case of opposing the two heads 11k-1 to each other, positions of the respective nozzle arrays 47 are shifted with, e.g., a half pitch. As a result, the head unit 90 has 600 dpi which is two times as high as 300 dpi of one nozzle array 47.

The plurality of head units 90 are attached to the carriage 27 in the image forming apparatus. For example, as shown in FIG. 12, the end portions of one head array, e.g., the respective heads 11k-2 of the head unit 90-2 on one side are inserted and arranged in the respective spaces 92 between the end portions of the other head array, e.g., the respective heads 11k-2 of the head unit 90-1 on the other side.

In such a configuration, a length W₄ of the plate 91 in the direction of the nozzle array 47 is set to the following expression:
W₄≦W₂−2·W₃ (2)

A thickness B₁ of the peripheral portion of the nozzle plate 46 in the X-axis direction and an interval (an interval between the respective heads 11k-2) B₂ of the adjacent heads 11k-2 are set to the following expression:
B₂≧B₁ (3)
As a result, a gap between each head 11k-1 and each head 11k-2 adjacent to each other as seen from the X-axis direction of each nozzle array 47 can be set to zero, or these heads can partially overlap each other.

One end portion of each head 11k-1 is inserted and arranged in the space 92 between the respective heads 11k-2 adjacent to each other. Consequently, like the first embodiment, the entire liquid jet head can be reduced in size. Blurring due to the respective inks having the K color, the C color, the M color and the Y color on the recording medium 12 can be prevented from occurring.

A third embodiment according to the present invention will now be described hereinafter with reference to the accompanying drawings. It is to be noted that like reference numerals denote parts equal to those in FIG. 8, thereby eliminating their detailed explanation.

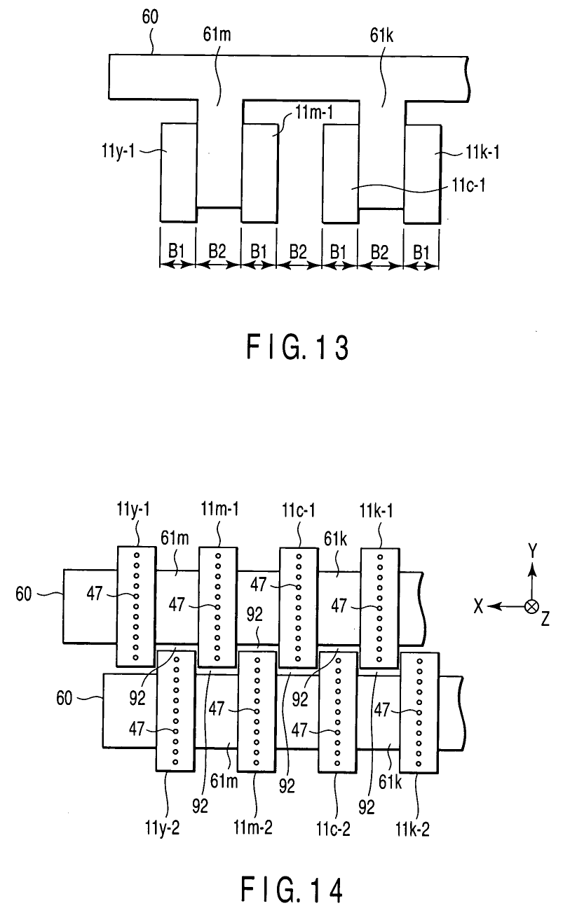

FIG. 13 is a block diagram showing a head unit for use in an image forming apparatus. The respective heads 11k-1, 11c-1, . . . , 11y-3 in the first embodiment, e.g., two heads 11k-1 and 11c-1 are provided on both sides of respective head attachment portions 61k and 61m provided on a head plate 60. A relationship between a thickness B₁ of the head 11k-1 and an interval B₂ between the adjacent heads 11k-1 and 11c-1 or the adjacent heads 11c-1 and 11m-1 are set to B₁≦B₂.

Consequently, as shown in FIG. 14, as to an arrangement of each head 11k-1, one end portion of each head 11k-1 is inserted and arranged in a space 92 between the respective heads 11k-2 and 11c-2 adjacent to each other. Therefore, like the first embodiment, the entire liquid jet head can be reduced in size. It is possible to avoid occurrence of blurring due to the respective inks having the K color, the C color, the M color and the Y color on the recording medium 12.

It is to be noted that the present invention is not restricted thereto, and can be modified as follows.

Although the respective inkjet heads 11k-1, 11c-1, . . . , 11y-3 utilizing the piezoelectric members 40 and 41 are used, the present invention is not restricted thereto. As the inkjet head, it is possible to apply, e.g., any other bubble jet type head unit having each nozzle array in which a plurality of nozzles are arranged.

As the recording medium 12, it is possible to use a cut sheet, a roll sheet and others.

The respective heads 11k-1, 11c-1, . . . , 11y-3 are fixed heads which do not move in the main scanning direction (the Y-axis direction). The present invention is not restricted thereto, and the respective heads 11k-1, 11c-1, . . . , 11y-3 may be moved. For example, the carriage 27 may be rotated 90 degrees around the Z axis to move the carriage 27 in the Y-axis direction, thereby effecting recording.

Although the respective heads 11k-1, 11c-1, 11m-1 and 11y-1 of the four colors, i.e., the K color, the C color, the M color and the Y color are provided in one head unit 10-1 or the like, it is possible to adopt a configuration in which two or more heads, e.g., the heads 11k-1 and 11c-1 or the nozzle array 47 are arranged.

Although the respective heads 11k-1, 11c-1, 11m-1 and 11y-1 of the four colors KCMY are provided in one head unit 10-1 or the like, the present invention is not restricted thereto, and each of the heads 11k-1, 11c-1, 11m-1 and 11y-1 may be configured to eject an ink of at least one of the K color, the C color, the M color and the Y color.

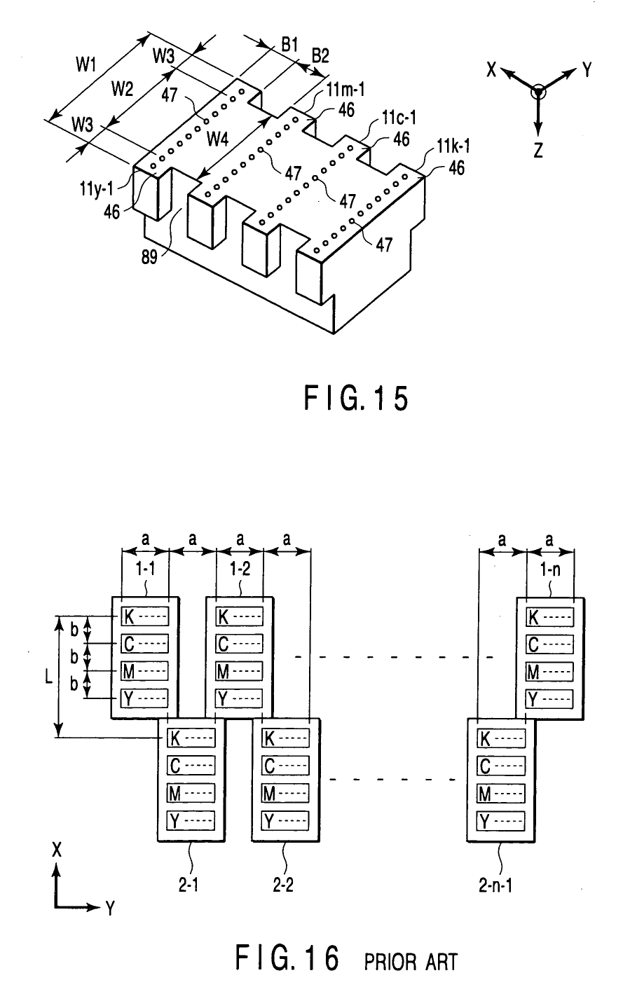

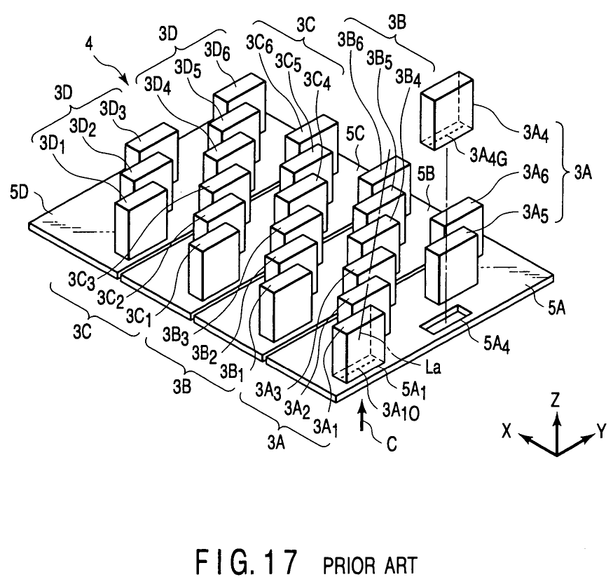

The four heads, e.g., the respective heads 11k-1, 11c-1, 11m-1 and 11y-1 are provided on the head plate 60 to constitute one head unit 10-1. The present invention is not restricted thereto, and the head plate 60 and the respective heads 11k-1, 11c-1, 11m-1 and 11y-1 may be integrally formed as shown in FIG. 15. In this case, if at least two nozzle arrays 47 are provided and each space 89 is formed between end portions of the respective nozzle arrays 47 in the nozzle array direction, the entire liquid jet head can be reduced in size, and blurring due to the inks of the respective colors on the recording medium 12 can be avoided like the first embodiment.

The present invention is not restricted to the inkjet printer, and the present invention can be applied to a liquid jet head which is used for ejecting a small amount of liquid droplets in a printer such as a copying machine or a facsimile machine which ejects liquid droplets with respect to the recording medium 12 to perform recording, a micro-eject apparatus for an adhesive, a manufacturing apparatus of a color filter in an LCD and others.

What is claimed is:

1. A liquid jet head comprising:
a plurality of heads each having a nozzle array in which a plurality of nozzles to eject at least liquid droplets are arranged in a line state,
wherein the respective heads are arranged in parallel at a second pitch in a second direction substantially orthogonal to a first direction which is an arrangement direction of the nozzle array to form at least two head arrays, and end portions on one side of the respective heads in one of the respective head arrays adjacent to each other are inserted and arranged in respective spaces between end portions on the other side of the respective heads in the other head array.

2. The liquid jet head according to claim 1, wherein a first pitch at which the at least two head arrays are arranged along the first direction is equal to or shorter than a length of the nozzle array in the head.

3. The liquid jet head according to claim 1, wherein an interval between the adjoining heads arranged in parallel at the second pitch is equal to or longer than a thickness of the head in the second direction.

4. A liquid jet head comprising:
at least two head units each having a plurality of heads, the head having a linear nozzle array which ejects at least liquid droplets being provided thereto,
wherein, in each of the at least two head units, the plurality of heads are arranged in parallel at a second pitch along a second direction substantially orthogonal to a first direction which is an arrangement direction of the nozzle array and, in the at least two head units, the plurality of heads are arranged in parallel a the first pitch along the first direction, end portions on one side of the respective heads in one of the heads units adjacent to each other are inserted and arranged in respective spaces between end portions on the other side of the respective heads in the other head unit.

5. The liquid jet head according to claim 4, wherein the first pitch at which the at least two head units are arranged is equal to or shorter than a length of the nozzle array in each head.

6. The liquid jet head according to claim 4, wherein an interval between the adjoining heads arranged in parallel at the second pitch is equal to or longer than a thickness of the head in the second direction.

7. The liquid jet head according to claim 4, wherein each of the plurality of heads has each nozzle plate on which the nozzle array is provided,
each nozzle plate has each plate end portion on which each nozzle array is not provided at both end portions, and
the at least two head units are arranged in parallel in such a manner that the plate end portions of each head in one of the head units overlap the plate end portions of each head in the other head unit as seen from the second direction.

8. The liquid jet head according to claim 7, wherein the respective head units are arranged in such a manner that a position of an end portion on one side of each nozzle array in one of the head units matches with a position of an end portion on the other side of each nozzle array in the other head units as seen from the second direction.

9. The liquid jet head according to claim 7, wherein the respective head units are arranged in such a manner that an end portion on one side of each nozzle array in one of the head units overlaps an end portion on the other side of each nozzle array in the other head unit as seen from the second direction.

10. The liquid jet head according to claim 4, wherein the head unit has a holding member having a plurality of head attachment portions provided at the second pitch, and
each head is attached to each head attachment portion.

11. The liquid jet head according to claim 10, wherein a width of each of the plurality of head attachment portions of the holding member is formed shorter than a length of the nozzle array of each of the plurality of heads.

12. The liquid jet head according to claim 10, having a substrate which performs electrical connection with respect to the plurality of heads,
wherein the substrate is provided on the holding member.

13. The liquid jet head according to claim 4, wherein, in each head unit, the at least two heads are combined to face each other and arranged at the second pitch in the second direction.

14. The liquid jet head according to claim 4, wherein, in each head unit, the at least two heads are integrally provided at the second pitch in the second direction.

15. The liquid jet head according to claim 4, wherein the liquid droplets have an ink of a black color, an ink of a cyan color, an ink of a magenta color and an ink of a yellow color, and
the respective heads in each head unit eject the ink of the black color, the ink of the cyan color, the ink of the magenta color and the ink of the yellow color.

16. The liquid jet head according to claim 4, having a plurality of liquid supply paths through which the liquids are supplied to the respective heads, and
the plurality of liquid supply paths are provided in respective spaces formed between the respective heads.

17. A liquid jet head comprising:
a plurality of head units each of which has a plurality of heads attached to a holding member, each of the plurality of heads having a linear nozzle array which eject at least liquid droplets,
each of the plurality of heads having each nozzle plate on which the nozzle array is provided,
each nozzle plate having each plate end portion on which each nozzle array is not provided at both end portions; and
a unit attachment member having a head unit attachment portion which is used to attach the plurality of head units at a first predetermined pitch in a first direction which is an arrangement direction of the nozzle array,
the holding member having a plurality of head attachment portions to which the plurality of heads are attached at a second pitch along a second direction substantially orthogonal to the first direction,
wherein each interval between the plurality of head units in the first direction is positioned, a position of an end portion on one side of each nozzle array in one of the head units is matched with a position of an end portion on the other side of each nozzle array in the other head unit as seen from the second direction, or the end portion on one side of each nozzle array in one of the head units overlap the end portion on the other side of each nozzle array in the other head unit as seen from the second direction.

18. The liquid jet head according to claim 17, wherein the holding member and the unit attachment member have the same thermal expansion coefficient.

19. The liquid jet head according to claim 17, wherein the liquid droplets have an ink of a black color, an ink of a cyan color, an ink of a magenta color, an ink of a yellow color, and
the respective heads in each head unit eject the ink of the black color, the ink of the cyan color, the ink of the magenta color and the ink of the yellow color.

20. The liquid jet head according to claim 17, having a plurality of liquid supply paths through which the liquids are supplied to the respective heads,
wherein the plurality of liquid supply paths are provided in respective spaces formed between the respective heads.

21. The liquid jet head according to claim 17, wherein the plurality of head attachment portions transmit heat generated in the plurality of heads from the holding member to the unit attachment member to release the heat.

22. The liquid jet head according to claim 17, wherein, in case of attaching the plurality of heads to the plurality of head attachment portions, a widthwise length W₄ of the plurality of head attachment portions in the holding member has a relationship satisfying the following expression:
W₄≦W₂−2·W₃
where W₂ is a length along which the nozzle array is provided in the nozzle plate, and W₃ is a length of the plate end portion.

23. The liquid jet head according to claim 17, wherein, in case of attaching the plurality of heads to the plurality of head attachment portions, the liquid jet head has a relationship satisfying the following expression:
B₂≧B₁
where B₁ is a thickness of the head in the second direction, and B₂ is an interval between the-adjoining heads provided in parallel at the second pitch.

24. The liquid jet head according to claim 17, wherein, in case of attaching the plurality of heads to the plurality of head attachment portions, the liquid jet head has a relationship satisfying the following expression:
W₄≦W₂−2·W₃ and B₂≧B₁
where W₂ is a length along which the nozzle array is provided in the nozzle plate, W₃ is a length of the plate end portion, W₄ is a width of the plurality of head attachment portions in the holding member, B₁ is a thickness of the head in the second direction, and B₂ is an interval between the adjoining heads provided in parallel at the second pitch.

25. The liquid jet head according to claim 17, having a substrate which performs electrical connection with respect to the plurality of heads,
wherein the substrate is provided on the holding member.
